(19) United States
(12) Patent Application Publication
(10) Pub. No.: US 2026/0023779 A1
(43) Pub. Date: Jan. 22, 2026

(54) METHODS AND SYSTEMS FOR DIGITAL MEDIA FILE IDENTIFICATION AND INGESTION

(71) Applicant: Arya Shapouri, Santa Monica, CA (US)

(72) Inventor: Arya Shapouri, Santa Monica, CA (US)

(21) Appl. No.: 19/270,844

(22) Filed: Jul. 16, 2025

Related U.S. Application Data
(60) Provisional application No. 63/672,141, filed on Jul. 16, 2024.

(51) Int. Cl. G06F 16/61; G06F 16/638

(52) U.S. Cl. CPC G06F 16/61; G06F 16/638

(57) ABSTRACT

Computerized methods and apparatuses for digital media file identification and ingestion include a server computing device that captures, from a first data source, media catalog information associated with an entity based upon first entity indicia. The server compiles the media catalog information into a first data structure. The server captures, from a second data source, one or more digital media files associated with the entity based upon second entity indicia. The server scans the digital media files for compliance with ingestion criteria. The server compiles metadata for the digital media files into a second data structure. The server generates a package file comprising the first data structure, the second data structure, and the digital media files for ingestion by a digital media storage and distribution platform.

### RELATED APPLICATION(S)

This application claims priority to U.S Provisional Patent Application No. 63/672,141, filed on Jul. 16, 2024, the entirety of which is incorporated herein by reference.

### TECHNICAL FIELD

This application relates generally to methods and apparatuses, including computer program products, for digital media file identification and ingestion.

### BACKGROUND

With the explosion of social media and digital streaming services, and availability of affordable high-quality recording and music production equipment, independent artists have been able to create and distribute their music to a worldwide audience without first being signed to a record label. However, record labels still offer independent artists many advantages over the emerging ‘do-it-yourself’ distribution model—including access to mainstream music distribution channels (e.g., radio, television, live performance venues) and an array of support resources to advance the artist's career.

When signing a new artist, record labels often obtain distribution rights to music that the artist has previously created and distributed themselves (also called the artist's ‘back catalog’). To effectively distribute and monetize the back catalog, record labels must ingest the digital media files into their proprietary content storage and distribution systems. Especially in the case of small, independent artists, the digital media files containing the back catalog music are often uploaded directly by the artist to many different content platforms (e.g., Spotify®, SoundCloud™, YouTube®, TikTok™). As a result, the availability and integrity of the digital media files and corresponding metadata on these content platforms may be inconsistent or incomplete. In addition, current digital media ingestion platforms operated by record labels lack functionality to interface with third-party content platforms for the identification and retrieval of a new artist's back catalog without resorting to a time-consuming and expensive process to search for and validate the digital media files and metadata—directly leading to a loss of revenue for the record label due to the delay in being able to distribute and monetize the artist's existing works.

### SUMMARY

Therefore, what is needed are methods and system for efficient and accurate ingestion of digital media files and related information hosted by multiple different data sources across a distributed computing environment.

The invention, in one aspect, features a system for digital media file identification and ingestion. The system comprises a server computing device with a memory for storing computer-executable instructions and a processor that executes the computer-executable instructions. The server computing device captures, from a first data source, media catalog information associated with an entity based upon first entity indicia provided by a client computing device. The server computing device compiles the media catalog information into a first data structure. The server computing device captures, from a second data source, one or more digital media files associated with the entity based upon second entity indicia provided by the client computing device. The server computing device scans the one or more digital media files for compliance with one or more ingestion criteria. The server computing device compiles metadata for the one or more digital media files into a second data structure. The server computing device generates a package file comprising the first data structure, the second data structure, and the one or more digital media files for ingestion by a digital media storage and distribution platform.

The invention, in another aspect, features a computerized method of digital media file identification and ingestion. A server computing device captures, from a first data source, media catalog information associated with an entity based upon first entity indicia provided by a client computing device. The server computing device compiles the media catalog information into a first data structure. The server computing device captures, from a second data source, one or more digital media files associated with the entity based upon second entity indicia provided by the client computing device. The server computing device scans the one or more digital media files for compliance with one or more ingestion criteria. The server computing device compiles metadata for the one or more digital media files into a second data structure. The server computing device generates a package file comprising the first data structure, the second data structure, and the one or more digital media files for ingestion by a digital media storage and distribution platform.

Any of the above aspects can include one or more of the following features. In some embodiments, the server computing device interfaces with the first data source using a first application programming interface (API) and the server computing device interfaces with the second data source using a second API. In some embodiments, scanning the one or more digital media files for compliance with one or more ingestion criteria comprises, for each digital media file: generating a fingerprint of an audio waveform of the digital media file; comparing the fingerprint to a plurality of fingerprints generated from reference audio waveforms; and flagging the digital media file as non-compliant upon determining that the fingerprint of the digital media file matches at least one of the fingerprints of the reference audio waveforms. In some embodiments, scanning the one or more digital media files for compliance with one or more ingestion criteria comprises, for each digital media file: determining an audio resolution of an audio waveform of the digital media file; and flagging the digital media file as non-compliant upon determining that the audio resolution of the digital media file is lower than a threshold audio resolution.

Other aspects and advantages of the technology will become apparent from the following detailed description, taken in conjunction with the accompanying drawings, illustrating the principles of the technology by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for digital media file identification and ingestion.

FIG. 2 is a flow diagram of a computerized method of digital media file identification and ingestion.

FIG. 3 is a diagram of a user interface for initiating media catalog capture.

FIG. 4 is a workflow diagram of a computerized process for capturing media catalog information.

FIG. 5 is a diagram of a user interface for selecting albums for ingestion.

FIGS. 6A and 6B depict an exemplary CSV file format.

FIG. 7 is a diagram of a user interface for initiating media file capture.

FIG. 8 is a workflow diagram of a computerized process for capturing media files.

### DETAILED DESCRIPTION

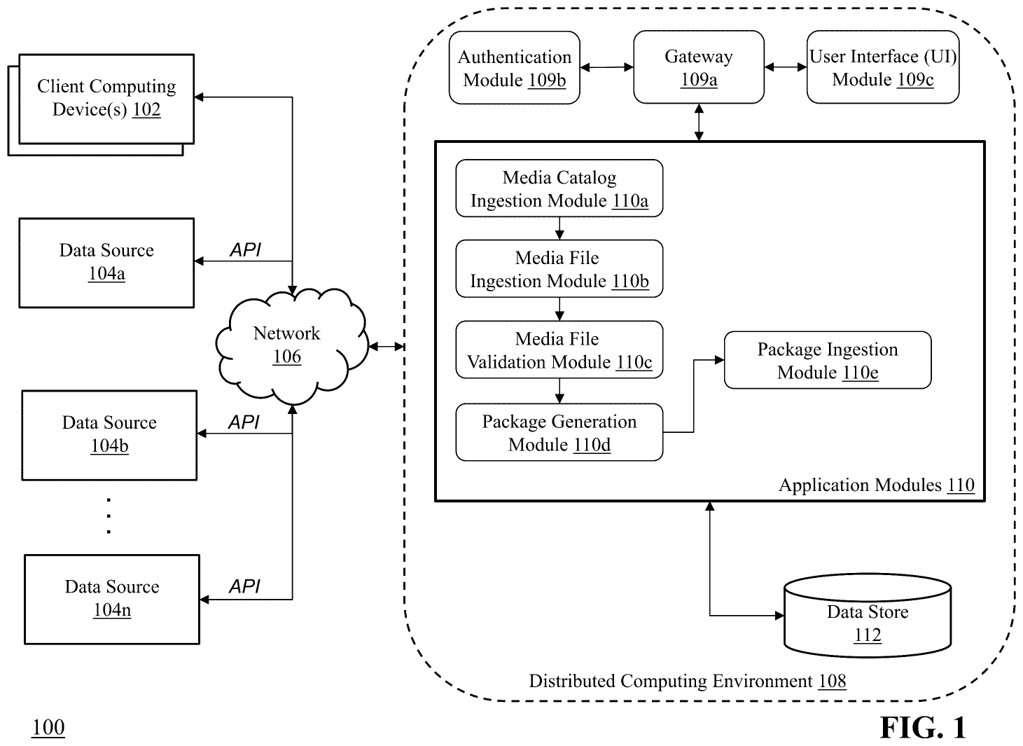

FIG. 1 is a block diagram of system 100 digital media file identification and ingestion. System 100 includes client computing devices 102, data sources 104a-104n, communication network 106, distributed computing environment 108 with gateway 109a, authentication module 109b, user interface (UI) module 109c, application modules 110, and data store 112.

Client computing devices 102 connect to communication network 106 in order to establish a session with one or more computing devices in distributed computing environment 108 to interact with applications (e.g., web interfaces) hosted by environment 108 and participate in one or more interactive application sessions relating to digital media file identification and ingestion. As can be appreciated, distributed computing environment 108 can be configured to include one or more computing devices that host websites or web applications, and/or connect to other computing devices that provide web-related content to client computing devices 102. For example, client computing devices 102 can establish a communication session with gateway 109a and UI module 109c of distributed computing environment 108 (e.g., via HTTP or HTTPS) using a uniform resource locator (URL) assigned to one or more computing devices in distributed computing environment 108 and receive website and/or web application content from distributed computing environment 108. A user at a client computing device can interact with (e.g., browse) the web application by activating links and navigating through various pages of the web application. In some embodiments, each page or section of the web application is associated with a particular URL. In some embodiments, client computing devices 102 are each coupled to an associated display device (not shown). For example, client computing devices 102 can provide a graphical user interface (GUI) via the display device that is configured to receive input from a user and to present output (e.g., web application content) to that user. In some embodiments, client computing devices 102 can be configured to connect to distributed computing environment 108 via network 106.

Exemplary client computing devices 102 include but are not limited to desktop computers, laptop computers, tablets, mobile devices, smartphones, and internet appliances. It should be appreciated that other types of computing devices that are capable of connecting to the components of system 100 can be used without departing from the scope of invention. It should be appreciated that system 100 can include any number of client computing devices operated by the same user or by different users. In some embodiments, a user of a client computing device can be a specialist that is tasked with identifying, collecting, and preparing digital media files for ingestion to a digital media storage and distribution platform. As just one use case, the specialist can be A&R (artist and repertoire) staff at a record label that is responsible for capturing and ingesting a back catalog of artist music, comprised of digital audio and/or video files, into the record label's digital distribution platform. Although the examples provided in this specification are primarily illustrative of this use case, it should be appreciated that the methods and systems described herein are not limited to such use case(s) and are equally applicable to a wide variety of digital media types and/or digital file types (e.g., audio, video, images, non-fungible tokens (NFTs), source code files, and similar digital assets).

Data sources 104a-104n can connect to communication network 106 in order to establish a session with distributed computing environment 108 for the transmission of digital media files and related data/metadata to one or more modules 110a-110e of distributed computing environment 108. For example, each data source 104a-104n can be hosted or made available at a separate server computing device or network resource that is coupled to network 106. Each data source 104a-104n is accessible to modules 110 of distributed computing environment 108 via an application programming interface (API), where modules 110 can issue API calls to the respective data sources 104a-104n, which process the API calls and return responsive data/metadata to the requesting modules 110. Generally, an API is a collection of functions, procedures, definitions, and protocols that enable integration of application software. API requests and responses can be exchanged between data sources 104a-104n and modules 110 of distributed computing environment 108 using any of a number of different architectures, including but not limited to: Representational State Transfer (REST) or Simple Object Access Protocol (SOAP). In one implementation of the REST architecture that can be used in system 100, for example, resources are accessed using Uniform Resource Identifiers (URIs) and requests/responses are exchanged using Hypertext Transfer Protocol (HTTP). It should be appreciated that data sources 104a-104n can be accessed by modules 110 of distributed computing environment 108 using other techniques or protocols.

Communication network 106 enables client computing devices 102 and data sources 104a-104n to communicate with computing devices in distributed computing environment 108. Network 106 is typically a wide area network, such as the Internet and/or a cellular network. In some embodiments, network 106 is comprised of several discrete networks and/or sub-networks (e.g., cellular to Internet).

Distributed computing environment 108 is a combination of hardware, including one or more computing devices comprised of special-purpose processors and one or more physical memory modules, and specialized software—such as gateway 109a, authentication module 109b, UI module 109c application modules 110, and data store 112—that are executed by the computing devices in distributed computing environment 108, to receive data requests and/or responses from client computing devices 102 and/or data sources 104a-104n, process the data requests, and provide responses to the data requests. Exemplary distributed computing platforms that can be used for cloud computing environment 108 include, but are not limited to, Amazon® Web Services (AWS); IBM® Cloud™; and Microsoft® Azure™. It should be appreciated that other types of computing resource distribution and configuration in a distributed computing environment can be used within the scope of the technology described herein.

Gateway 109a acts as an entry point for client computing devices 102 and data sources 104a-104n to interface with computing modules 110 hosted by distributed computing environment 108. Generally, gateway 108 receives data requests and/or messages from client computing devices 102 and data sources 104a-104n, processes the requests and/or messages (e.g., according to defined application functionality provided by modules 110), and returns responses to client computing devices 102 and data sources 104a-104n. In some embodiments, gateway 109a in conjunction with authentication module 109b performs functions relating to authentication, security, and policy enforcement. For example, gateway 109a can receive identifying indicia (e.g., authentication credentials, API tokens, etc.) from client computing devices 102, data sources 104a-104n, and/or modules 110 as part of a communication between them, and authentication module 109b can validate the identifying indicia before enabling client computing devices 102 and data sources 104a-104n to access application functions of modules 110 and/or data available from data store 112 in distributed computing environment 108. Similarly, when modules 110 communicate with data sources 104a-104n, gateway 109a and authentication module 109b can operate to generate and/or retrieve authentication data (e.g., API tokens) when establishing a connection to data sources 104a-104n. User interface (UI) module 109c is configured to generate user interface screens and/or user interface elements for display on, e.g., client computing devices 102 as part of the functionality for digital media file identification and ingestion as described herein.

Application modules 110 are specialized sets of computer software instructions programmed onto one or more dedicated processors of computing devices in distributed computing environment 108. Modules 110 can specifically designate memory locations and/or registers for executing the specialized computer software instructions. Modules 110 include media catalog ingestion module 110a, media file ingestion module 110b, media file validation module 110c, package generation module 110d, and package ingestion module 110e. Although modules 110 are shown in FIG. 1 as executing within distributed computing environment 108, in some embodiments the functionality of modules 110 can be distributed among a plurality of environments and/or computing devices within an environment. As shown in FIG. 1, modules 110 communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. In some embodiments, application modules 110 can comprise one or more programmatic scripts that are executed by one or more processors in distributed computing environment 108. For example, modules 110 can incorporate Python scripts, where each script contains source code for performing specific tasks in the context of digital media file identification and ingestion as described herein.

Data store 112 is located on a computing device (or in some embodiments, on a set of computing devices) in cloud computing environment 108. In some embodiments, data store 112 is configured to receive, generate, and store specific segments of data relating to the process of digital media file identification and ingestion as described herein. In some embodiments, all or a portion of data store 112 can be integrated with gateway 109a, authentication module 109b, UI module 109c, and/or application modules 110. Data store 112 can comprise one or more databases, data warehouses, and/or data lakes configured to store portions of data used by other components of system 100.

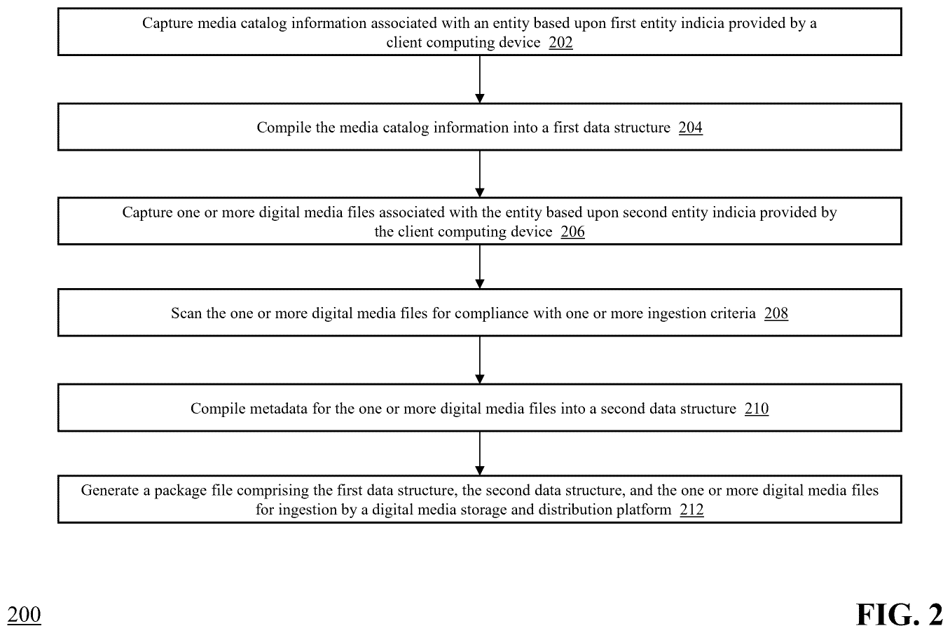

FIG. 2 is a flow diagram of a computerized method 200 of digital media file identification and ingestion, using system 100 of FIG. 1. As described above, system 100 can be configured to enable end users to perform tasks associated with digital media file identification and ingestion. The techniques described herein can advantageously provide for a streamlined and efficient digital media file collection and ingestion process whereby system users automatically initiate the identification and capture of designated digital media files that are located in distributed data sources across a network into a unified package format that is easily ingestible by a digital media storage and distribution platform.

In one example embodiment, a user at a first one of the client computing devices 102 establishes a connection between the first client device and gateway 109a of environment 108. User interface module 109c generates a user interface screen for display on the first client device to enable media catalog ingestion module 110a to capture (step 202) media catalog information associated with an entity based upon first entity indicia provided by the user at the first client computing device 102. Generally, an entity can be a person (e.g., musician, actor, producer, athlete), an organization (e.g., film studio, record label, sports team), or another type/group that is associated with digital assets, including but not limited to digital media such as audio files, video files, and so forth.

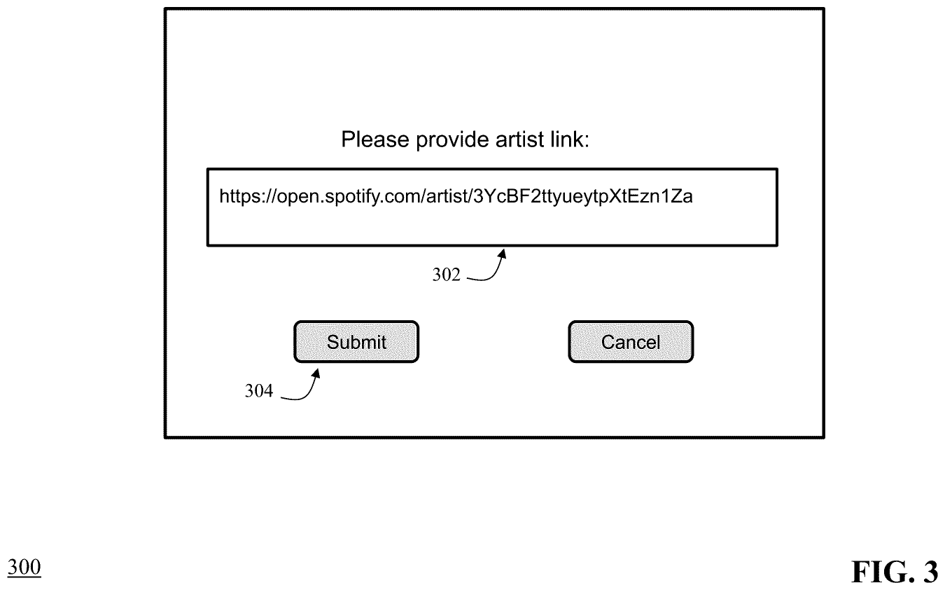

FIG. 3 is a diagram of a user interface 300 for initiating media catalog capture. As mentioned above, the primary use case described in this specification is for ingestion of a music artist's back catalog of audio files into a record label's storage and distribution platform. As shown in FIG. 3, a user (e.g., A&R rep) at the first client computing device 102 navigates to a website (or other network resource) for the digital media file ingestion application provided by modules 110 (client computing device 102 establishes connection to distributed computing environment 108 via gateway 109a). Media catalog ingestion module 110a invokes UI module 109c to generate a media catalog ingestion form for display to the user at the first client computing device 102. The media catalog ingestion form includes form field 302 for inputting an artist link (e.g., URL) that references a location at data source 104a from which information about the artist's music catalog can be accessed. In this example, the user at client computing device 102 has provided a URL (i.e., open.spotify.com/artist/3YcBF2ttyueytpXtEzn1Za) for the artist's profile on the Spotify® music streaming platform (spotify.com), where the string ‘3YcBF2ttyueytpXtEzn1Za’ corresponds to the artist ID. As can be appreciated, an artist's profile can comprise artist information (e.g., name, bio), as well as references to album information and track information (e.g., album titles, track listings, release dates, song credits). In some embodiments, the references to album information and track information can comprise additional URLs that are accessed separately from the artist URL. The user at the first client computing device enters data into form field 302 and submits the data to media catalog ingestion module 110a using button 304. In some embodiments, the user can copy the complete artist URL from, e.g., the Spotify® desktop application and paste the URL into form field 302. Media catalog ingestion module 110a captures the media catalog indicia provided by the end user and stores the media catalog indicia in data store 112, e.g., as part of a ingestion log.

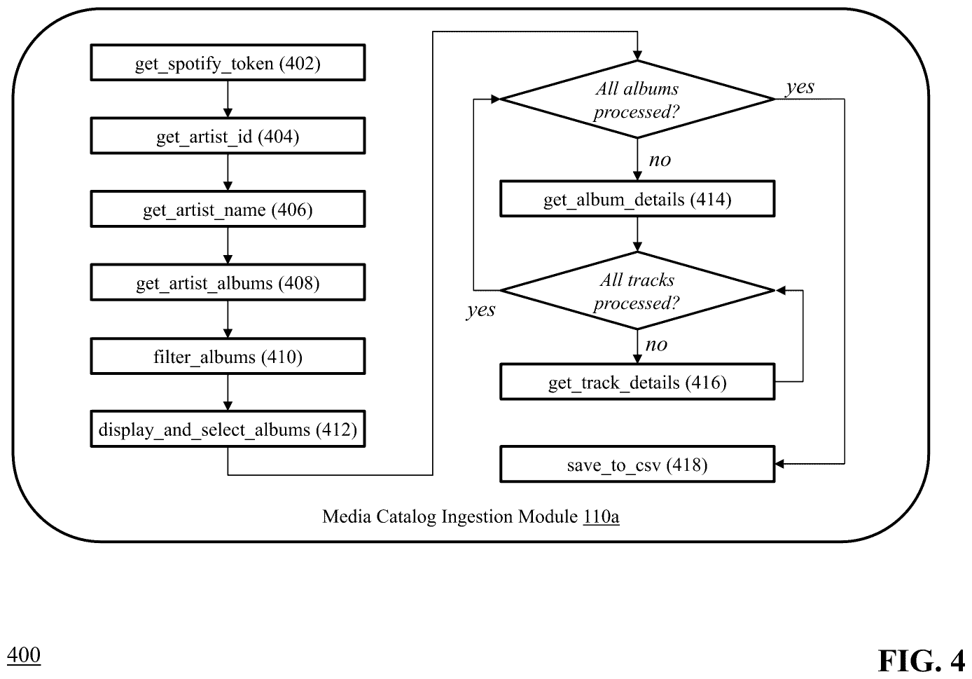

Next, media catalog ingestion module 110a establishes a connection to the resource (i.e., data source 104a) referenced in the media catalog indicia provided by the user of client computing device 102 and captures available media catalog information from data source 104a. In this example, data source 104a is the Spotify® music streaming platform and module 110a can interface with data source 104a using the Spotify® Web API (described at developer.spotify.com/documentation/web-api). FIG. 4 is a workflow diagram of a computerized process 400 for capturing media catalog information from data source 104a using media catalog ingestion module 110a. As shown in FIG. 4, each step 402-418 of workflow 400 corresponds to a function contained in a Python script executed using media catalog ingestion module 110a.

Using the artist URL as input, media catalog ingestion module 110a calls the get_spotify token function (402). This function transmits a POST request to the Spotify token endpoint (i.e., accounts.spotify.com/api/token) at data source 104a, and the request includes authentication credentials (client_id and client_secret). Data source 104a processes the request to authenticate module 110a using the authentication credentials, and data source 104a returns an access token to enable module 110a to request and retrieve artist-related data from data source 104a. Exemplary pseudocode for the get_spotify_token function is provided below:

```
def get_spotify_token(client_id, client_secret):
  url = ‘https://accounts.spotify.com/api/token’
  headers = {
    ‘Authorization’: ‘Basic ’ +
base64.b64encode(f‘{client_id}:{client_secret}’.encode( )).decode( )
  }
  data = {
    ‘grant_type’: ‘client_credentials’
  }
  response = requests.post(url, headers=headers, data=data)
  response.raise_for_status( )
  return response.json( )[‘access_token’]
```

Once media catalog ingestion module 110a has obtained the access token, module 110a calls the get_artist_id function (404). This function parses the input URL received from the user of client computing device (via form field 302) to extract the artist ID and store the extracted artist ID in a Python variable (e.g., ‘{artist_id}’). As mentioned previously, if the input URL is:
https://open.spotify.com/artist/3YcBF2ttyueytpXtEzn1Za
   the get_artist_id function extracts the artist ID string ‘3YcBF2ttyueytpXtEzn1Za’ using, e.g., a Python split function to capture the portion of the URL after the final forward slash.

Next, media catalog ingestion module 110a calls the get_artist_name function (406) using the artist ID as an input variable. This function generates an API call that requests artist data from data source 104a, including generating a URL by appending the artist ID string extracted above to the following URL:
https://api.spotify.com/v1/artists/{artist_id}

In response to this request, data source 104a returns a JSON data structure that contains certain data/metadata associated with the corresponding artist, including the artist's name. Media catalog ingestion module 110a stores the received artist data in a Python object (e.g., ‘artist_data’). In some embodiments, the get_artist_name function returns a string containing the artist's name. Exemplary pseudocode for the get_artist_name function is provided below:

```
def get_artist_name(artist_id, token):
  url = f‘https://api.spotify.com/v1/artists/{artist_id}’
  headers = {
    ‘Authorization’: f‘Bearer {token}’
  }
  response = requests.get(url, headers=headers)
  response.raise_for_status( )
  artist_data = response.json( )
  return artist_data[‘name’]
```

Media catalog ingestion module 110a then calls the get_artist_albums function (408) using the artist ID as an input variable. This function generates an API call that requests album data for the specified artist ID from data source 104a, including generating a URL by inserting the artist ID string extracted above into the following URL:
https://api.spotify.com/v1/artists/{artist_id}/albums?include_groups=album,single,compilation&limit=50

In response to this request, data source 104a returns a JSON data structure that contains certain data/metadata associated with the albums, such as the Spotify® album ID, album title, and release date. Media catalog ingestion module 110a stores the received album data in a Python list object (e.g., ‘albums’). In some embodiments, the get_artist_albums function cycles through the received album data to add each album as an item to the Python list (e.g., using the. extend method). Exemplary pseudocode for the get_artist_albums function is provided below:

```
def get_artist_albums(artist_id, token):
  albums = [ ]
  url =
f‘https://api.spotify.com/v1/artists/{artist_id}/albums?include_groups=album,
single,compilation&limit=50’
  headers = {
    ‘Authorization’: f‘Bearer {token}’
  }
  while url:
    response = requests.get(url, headers=headers)
    if response.status_code != 200:
      print(f“Failed to retrieve albums: {response.status_code}”)
      print(response.text)
      return albums
    data = response.json( )
    if ‘items’ in data:
      albums.extend(data[‘items’])
    else:
      print(f“Unexpected response structure: {json.dumps(data,
indent=2)}”)
      break
    url = data.get(‘next’)
return albums
```

Next, media catalog ingestion module 110a calls the filter_albums function (410) using the ‘albums’ list and the ‘{artist ID}’ variable as input variables. The filter_albums function operates in several ways, including to remove duplicate albums from the albums list and to filter the list of albums for a given artist to only show a specified subset of albums. As can be appreciated, data source 104a may maintain a plurality of data records for the same artist ID across multiple albums, e.g., the artist is featured on or appears on other albums where the artist is not the primary contributor. Instead of including each data record in the albums list, the filter_albums function can filter the albums list to only show desired configurations for the artist, i.e., singles or albums or compilations. Exemplary pseudocode for the filter_albums function is provided below:

```
def filter_albums(albums, artist_id):
  seen = set( )
  filtered_albums = [ ]
  for album in albums:
    if album[‘album_type’] in [‘album’, ‘single’, ‘compilation’] and
artist_id in [artist[‘id’] for artist in album[‘artists’]]:
      if album[‘id’] not in seen:
        seen.add(album[‘id’])
        filtered_albums.append(album)
  return filtered_albums
```

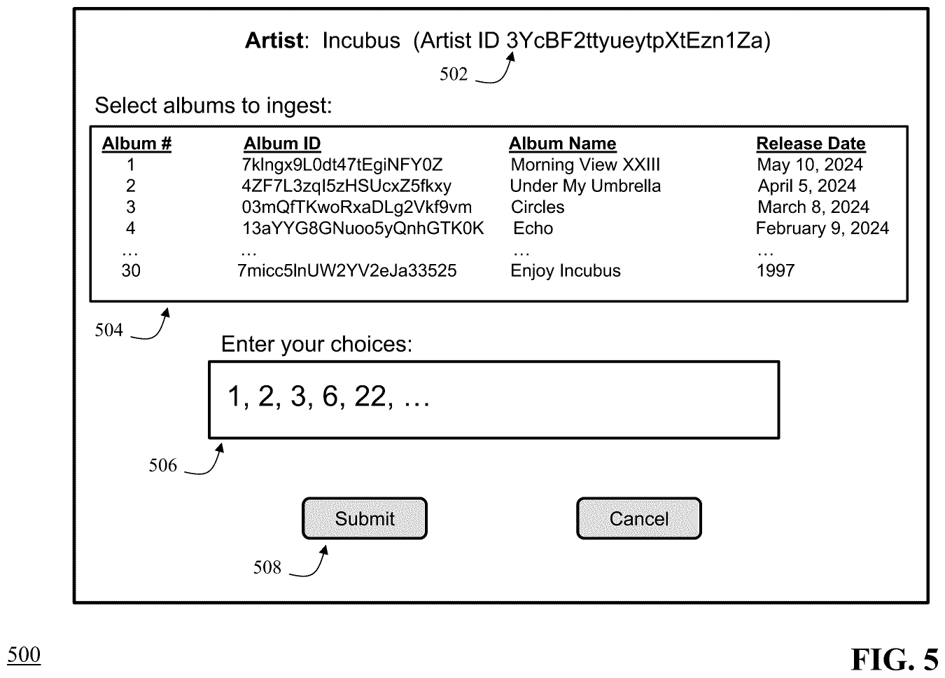

Media catalog ingestion module 110a calls the display_and_select_albums function (412) to capture input from the user at client computing device 102 relating to which album(s) should be included in the media file ingestion. Using the ‘albums’ list as an input variable (which has been filtered as described above), module 110a calls the display_and_select_albums function which invokes UI module 109c to generate an album selection form for display to the user at the first client computing device 102. FIG. 5 is a diagram of a user interface 500 for selecting albums for ingestion. The album selection form includes artist identification field 502 (using data captured in the {artist_id} and artist name variables) and list field 504 for displaying the filtered album data as stored in ‘albums’ list object. In some embodiments, list field 504 includes an ‘Album #’ column that includes a numeric value assigned by module 110a to each item in the albums list object. User interface 500 also includes form field 506 in which the user can identify which album(s) should be selected for ingestion; the user can specify a comma-delimited list of ‘Album #’ values (from field 504). The user at the first client computing device 102 enters data into form field 506 and submits the data to media catalog ingestion module 110a using button 508. In some embodiments, the user can click on one or more albums displayed in list field 504 and user interface 500 can automatically generate the comma-delimited list shown in field 506. Media catalog ingestion module 110a captures the album selection indicia provided by the end user and stores the album selection indicia in data store 112, e.g., as part of an ingestion log.

Turning back to FIG. 4, once the album selection indicia are received from client computing device 102, media catalog ingestion module 110a initiates capture of album details, including track details for each album. As can be appreciated, an artist may have one or more albums in data source 104a, and each album may have one or more tracks. To efficiently capture the relevant album and track details, media catalog ingestion module 110a can use a recursive algorithmic approach (i.e., functions 414-416) as shown in FIG. 4.

First, module 110a calls the get_album_details function (414) for each album identified in the selection indicia. In some embodiments, the get_album_details function matches each ‘Album #’ value from the selection indicia to an item in the ‘albums’ list object, retrieves the corresponding Spotify® Album ID value(s) from the list item., and stores the Album ID value in a Python variable (e.g., {album_id}). Then, the get_album_details function generates an API call that requests album data for each album from data source 104a by forming a URL that appends the retrieved album ID string to the following URL:
https://api.spotify.com/v1/albums/{album_id}

In response to this request, data source 104a returns a JSON data structure that contains certain data/metadata associated with the corresponding album, including the album title, release date, album UPC, covert art image URL, album configuration, and music genre. The JSON data structure can also include information on each of the tracks on each album, arranged in a ‘tracks’ subsection of the JSON. Media catalog ingestion module 110a stores the received album data in a Python object (e.g., ‘album_details’). Exemplary pseudocode for the get_album_details function is provided below:

```
def get_album_details(album_id, token):
  url = f‘https://api.spotify.com/v1/albums/{album_id}’
  headers = {
    ‘Authorization’: f‘Bearer {token}’
  }
  response = requests.get(url, headers=headers)
  response.raise for status( )
  return response.json( )
```

Media catalog ingestion module 110a analyzes the data/metadata for each album in the ‘album_details’ object and stores relevant data elements in a ‘release_info’ Python list object.

An exemplary structure for the ‘release_info’ Python list object is provided below:

```
release_info = {
  ‘name’: album_details[‘name’],
  ‘release_date’: album_details[‘release_date’],
  ‘upc’: album_details[‘external_ids’].get(‘upc’, ‘UPC not available’),
  ‘cover_art_url’: album_details[‘images’][0][‘url’] if
album_details[‘images’] else ‘Cover art not available’,
  ‘configuration’: album_details[‘album_type’],
  ‘original_release_date’: album_details.get(‘release_date’, ‘Original
release date not available’),
  ‘genre’: ‘, ’.join(album_details[‘genres’]) if ‘genres’ in album_details
else ‘Genre not available’,
  ‘tracks’: [ ]
}
```

As displayed above, the release_info object includes a ‘tracks’ list object for each album. Module 110a analyzes the data/metadata for each track of the album in the ‘album_details’ object and stores relevant data elements in a ‘track_info’ Python list object. As part of this process, module 110a calls the get_track_details function (416) for each track identified in the album_details object. In some embodiments, the get_track_details function retrieves the corresponding Spotify® track ID value from the album_details object, and stores the track ID value in a Python variable (e.g., {track_id}). Then, the get_track_details function generates an API call that requests track data from data source 104a by forming a URL that appends the track ID string to the following URL:
https://api.spotify.com/v1/tracks/{track_id}

In response to this request, data source 104a returns a JSON data structure that contains certain data/metadata associated with the corresponding track, including the track number (e.g., as sequenced on the album), song title, track ISRC, track duration (e.g., seconds or milliseconds), and Spotify® URL for the specific track. Media catalog ingestion module 110a stores the received track data in a Python object (e.g., ‘track_details’). Exemplary pseudocode for the get_track_details function is provided below:

```
def get_track_details(track_id, token):
  url = f‘https://api.spotify.com/v1/tracks/{track_id}’
  headers = {
    ‘Authorization’: f‘Bearer {token}’
  }
  response = requests.get(url, headers=headers)
  response.raise_for_status( )
  return response.json( )
```

As shown in FIG. 4, media catalog ingestion module 110a repeats the get_track_details function for each track included in a corresponding album. When all tracks have been processed, module 110a calls the get_album_details function for the next album in the album_details object and executes functions 414, 416 for that album. As mentioned above, module 110a stores the album and track information for each album into a ‘release_info’ object. During the overall album data ingestion process, module 110a appends each ‘release_info’ object as an item in a ‘releases’ Python object.

Exemplary pseudocode for the recursive processing of albums and tracks into the ‘releases’ object (including calls to functions 414 and 416) as described herein is provided below:

```
releases = [ ]
track_titles = [ ]
selected_album_names = [ ]
for album in selected_albums:
  album_details = spotify.get_album_details(album[‘id’], token)
  release_info = {
      ‘name’: album_details[‘name’],
      ‘release_date’: album_details[‘release_date’],
      ‘upc’: album_details[‘external_ids’].get(‘upc’, ‘UPC not available’),
      ‘cover_art_url’: album_details[‘images’][0][‘url’] if
album_details[‘images’] else ‘Cover art not available’,
      ‘configuration’: album_details[‘album_type’],
      ‘original_release_date’: album_details.get(‘release_date’, ‘Original
release date not available’),
      ‘genre’: ‘, ’.join(album_details[‘genres’]) if ‘genres’ in
album_details else ‘Genre not available’,
      ‘tracks’: [ ]
  }
  for track in album details[‘tracks’][‘items’]:
      track_details = spotify.get_track_details(track[‘id’], token)
      track_info = {
        ‘number’: track[‘track_number’],
        ‘name’: track_details[‘name’],
        ‘isrc’: track_details[‘external_ids’].get(‘isrc’, ‘ISRC not
available’),
        ‘duration’: track_details[‘duration_ms’] // 1000,
        ‘url’: track_details[‘external_urls’][‘spotify’]
    }
    track_titles.append(track_info[‘name’])
    release_info[‘tracks’].append(track_info)
releases.append(release_info)
selected_album_names.append(album_details[‘name’])
```

When media catalog ingestion module 110a has completed processing data for all albums in the selection criteria, module 110a compiles (step 204 of FIG. 2) the media catalog information into a first data structure by calling the save_to_csv function (418) with the ‘releases’ object and artist_name string as input variables. This function writes a comma-separated value (CSV) file which includes all of the captured album and track data for the artist to, e.g., data store 112. Exemplary pseudocode for the save_to_csv function is provided below:

```
def save_to_csv(releases, artist_name):
  date_str = datetime.now( ).strftime(‘%Y-%m-%d’)
  filename = f“data/{artist_name}_{date_str}.csv”
  os.makedirs(os.path.dirname(filename), exist_ok=True)
  with open(filename, ‘w’, newline=‘’) as csvfile:
    fieldnames = [‘Release Name’, ‘Release Date’, ‘UPC’, ‘Cover Art URL’,
‘Configuration’, ‘Original Release Date’, ‘Genre’, ‘Track Number’, ‘Track
Name’, ‘ISRC’, ‘Duration’, ‘Track URL’]
    writer = csv.DictWriter(csvfile, fieldnames=fieldnames)
    writer.writeheader( )
    for release in releases:
      for track in release[‘tracks’]:
          writer.writerow({
            ‘Release Name’: release[‘name’],
            ‘Release Date’: release[‘release_date’],
            ‘UPC’: f“{release[‘upc’]}”,
            ‘Cover Art URL’: release[‘cover_art_url’],
            ‘Configuration’: release[‘configuration’],
            ‘Original Release Date’: release[‘original_release_date’],
            ‘Genre’: release[‘genre'],
            ‘Track Number’: track[‘number’],
            ‘Track Name’: track[‘name’],
            ‘ISRC’: track[‘isrc’],
            ‘Duration’: f“{track[‘duration’] // 60}m {track[‘duration’]
% 60}s”,
            ‘Track URL’: track[‘url’]
        })
  print(f“Data saved to {filename}”)
  return filename names.append(album_details[‘name’])
```

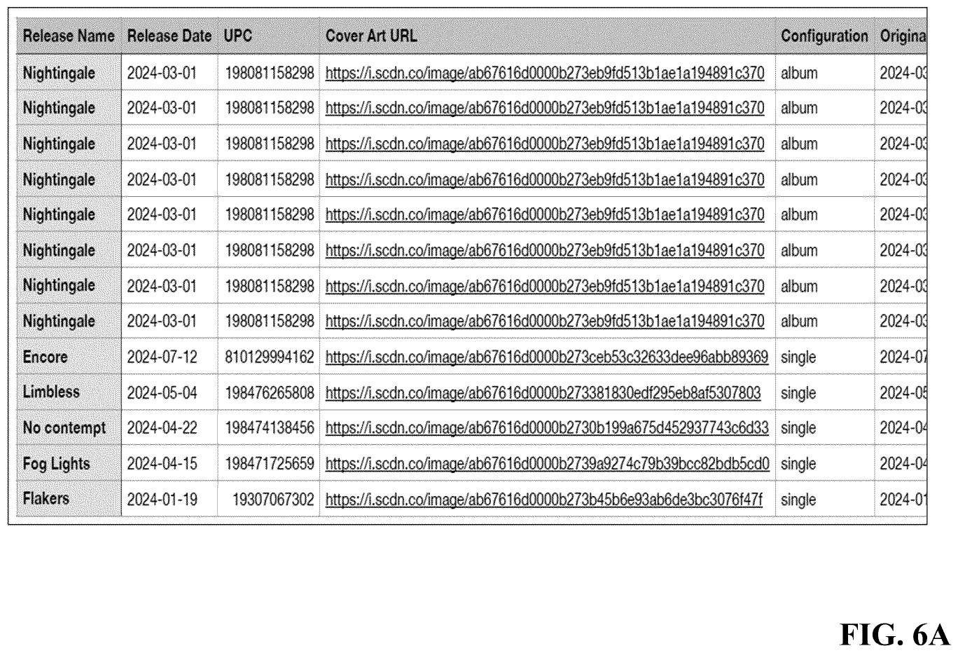

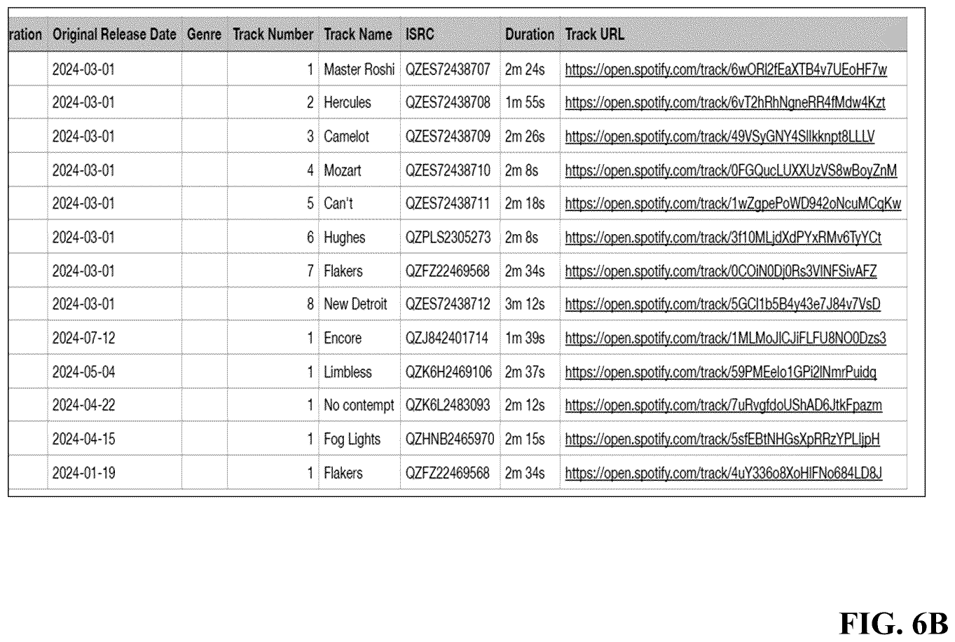

An exemplary CSV file format for the artist Lelo is provided in FIGS. 6A and 6B. The CSV file is illustratively arranged in tabular format for readability purposes, with a first part of the CSV file in FIG. 6A and the corresponding second part of the CSV file in FIG. 6B.

Turning back to FIG. 2, after compiling the media catalog information into a first data structure as described above, user interface module 109c generates a user interface screen for display on the client computing device 102 to enable media file ingestion module 110b to capture (step 206) one or more digital media files associated with the entity based upon second entity indicia provided by the user of client computing device 102. In some embodiments, media files associated with the entity can be hosted by data source 104b and made available for playback and/or download by requesting devices. For example, data source 104b can be the YouTube® video sharing platform. As can be appreciated, entities such as undiscovered musicians or other lesser-known digital media artists may upload their songs and/or music videos to the YouTube® platform in order to reach a worldwide audience. The digital media files made available on YouTube® can be captured and ingested by media file ingestion module 110b.

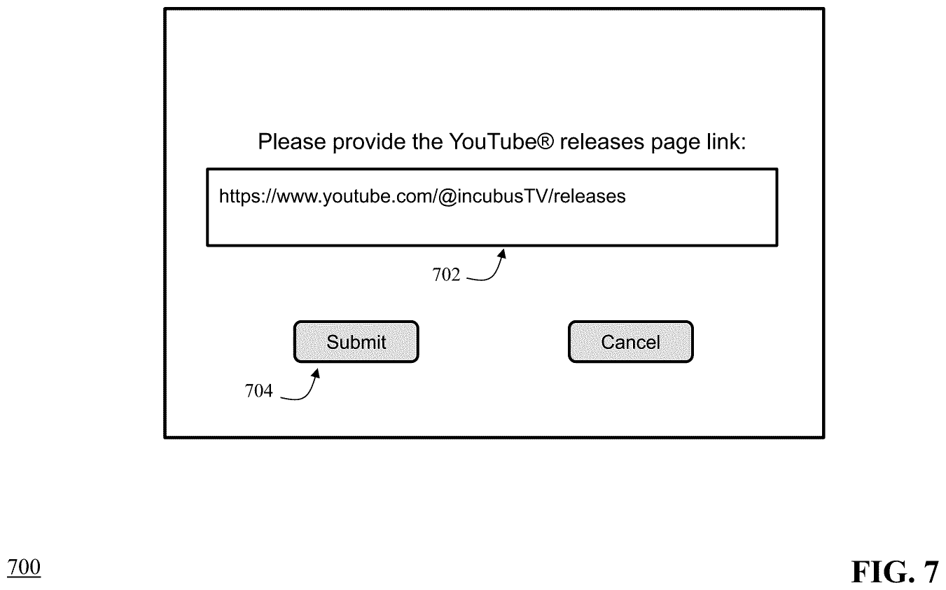

FIG. 7 is a diagram of a user interface 700 for initiating media file capture. Media file ingestion module 110b invokes UI module 109c to generate a media file ingestion form for display to the user at the first client computing device 102. The media file ingestion form includes form field 702 for inputting a YouTube® releases page link (e.g., URL) for the particular artist that references a location at data source 104b from which the artist's uploaded digital files can be accessed. Typically, the YouTube® releases page for a music artist comprises links to video playlists for each of the artist's albums, where each video in the playlist corresponds to a given track on the album. In this example, the user at client computing device 102 has provided a URL (i.e., https://www.youtube.com/@incubusTV/releases) for the artist's releases page on YouTube® (youtube.com), where the string ‘@incubusTV’ corresponds to the YouTube® artist identifier. In some embodiments, the user can copy the complete releases page URL from, e.g., YouTube® via a browser window and paste the URL into form field 702. Media file ingestion module 110b captures the media file indicia provided by the end user and stores the media file indicia in data store 112, e.g., as part of an ingestion log.

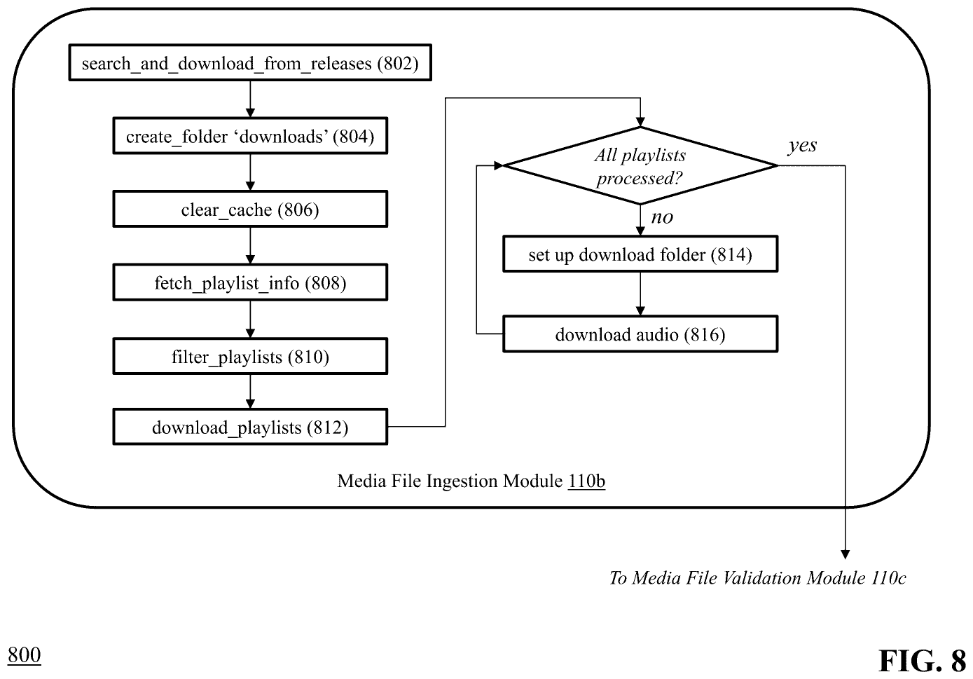

Next, media file ingestion module 110b establishes a connection to the resource (i.e., data source 104b) referenced in the media file indicia provided by the user of client computing device 102 and captures available media catalog information from data source 104a. In this example, data source 104b is the YouTube® video sharing platform and module 110b can interface with data source 104b using the yt-dlp command line audio/video downloader (available at github.com/yt-dlp/yt-dlp). FIG. 8 is a workflow diagram of a computerized process 800 for capturing media files from data source 104b using media file ingestion module 110b. As shown in FIG. 8, each step 802-816 of workflow 800 corresponds to functionality contained in a Python script executed using media file ingestion module 110b.

Using the releases page URL and selected_album_names object (see paragraph

above) as input, media file ingestion module 110b calls the search_and_download_from_releases function (802). This function initiates the process to identify and download media files using the releases page URL, including creating a folder in, e.g., data store 112 for storing the downloaded media files (804), clearing the download cache (806), fetching playlist info (808), filtering playlists (810), and downloading playlists (812). Each of these functions 804-812 is described in greater detail below. Exemplary pseudocode for the search_and_download_from_releases function is provided below:

```
def search_and_download_from_releases(youtube_releases_link,
selected_album_names):
  create_folder(‘downloads’)
  clear_cache( ) # Clear cache before downloading
  playlists = fetch_playlist_info(youtube_releases_link)
  filtered_entries = filter_playlists(playlists, selected_album_names)
  print(f“Found {len(filtered_entries)} matching playlists.”)
  if not filtered_entries:
    print(“No matching playlists found.”)
    return
  download_playlists(filtered_entries)
```

Media file ingestion module 110b first calls the create_folder function (804) to create a new data storage area in data store 112 which will contain the downloaded media files. In some embodiments, the data storage area is a traditional file structure maintained by an operating system of a computing device that houses data storage 112. In these embodiments, the create folder function creates a new folder (e.g., called ‘downloads’) at a specified path in the file structure. In one embodiment, module 110b uses the os.makedirs method in Python to create the data storage area.

Next, media file ingestion module 110b calls the clear_cache function (806). This function clears the yt-dlp cache to remove any partial downloads or other incomplete files that may exist in the yt-dlp tool in order to process the incoming media downloads, as well as ensuring that sufficient disk storage is available for the downloads.

Media file ingestion module 110b then calls the fetch_playlist_info function (808). This function generates an API call that requests playlist metadata for the specified releases page URL from data source 104b. In some embodiments, the playlist metadata includes the playlist title. As can be appreciated, the playlist title for a given album often includes the album title. Data source 104b processes the request to provide the playlist metadata to module 110b. In some embodiments, the response from data source 104b comprises a dictionary with information on each track in the playlist, including data elements such as: video ID, title, duration, and upload date. The fetch_playlist_info function is configured to scan each song in the playlists and compare them to the selected song titles/album titles that are received from data source 104a. Exemplary pseudocode for the fetch_playlist_info function is provided below:

```
def fetch_playlist_info(releases_url):
  with yt_dlp.YoutubeDL( ) as ydl:
    print(f“Extracting info from URL: {releases_url}”)
    result = ydl.extract_info(releases_url, download=False)
    return result
```

Media file ingestion module 110b calls the filter_playlists function (810). This function compares the playlist titles obtained using the fetch_playlist_info function to the album titles contained in the selected_album_names object. When a playlist title contains an album title, module 110b adds the playlist to a filtered_playlists list object. Exemplary pseudocode for the filter_playlists function is provided below:

```
def filter_playlists(playlists, selected_album_names):
  filtered_entries = [
    entry for entry in playlists.get(‘entries’, [ ])
    if ‘title’ in entry and any(album_name.lower( ) in
entry[‘title’].lower( ) for album_name in selected_album_names)
  ]
  return filtered_entries
```

Using the filtered_playlists object as input, media file ingestion module 110b calls the download_playlists function (812). This function issues a request to download all media files for each playlist identified in the filtered_playlists object and store the media files in a separate data storage area in data store 112. For example, module 110b can store each media file for a given playlist in a separate folder that includes the name of the playlist/album title. In some embodiments, the download_playlists function is configured to only download the audio portion of video files referenced in the playlists (e.g., by specifying certain configuration parameters when calling the underlying download function in yt-dlp. Exemplary pseudocode for the download_playlists function is provided below:

```
def download_playlists(filtered_entries):
  for entry in filtered_entries:
    release_name = entry[‘title’]
    playlist_url = f“https://www.youtube.com/playlist?list={entry[‘id’]}”
    # Set up download folder
    ydl_opts[‘outtmpl’] = f‘downloads/{release_name}/%(title)s.%(ext)s’
    with yt_dlp.YoutubeDL(ydl_opts) as ydl:
      print(f“Downloading playlist: {release_name}”)
      ydl.download([playlist_url])
```

with ydl_opts defined as:

```
ydl_opts = {
  ‘format’: ‘bestaudio/best’,
  ‘postprocessors’: [{
    ‘key’: ‘FFmpegExtractAudio’,
    ‘preferredcodec’: ‘wav’,
  }],
  ‘outtmpl’: ‘downloads/%(release_name)s/%(title)s.%(ext)s’,
  ‘cookiefile’: ‘cookies.txt’,
}
```

Turning back to FIG. 2, once media file ingestion module 110b has captured the digital media files from data source 104b as described above, media file validation module 110c scans (step 208) the one or more digital media files for compliance with one or more ingestion criteria. As can be appreciated, some of the digital media files captured from data source 104b may not comply with technical criteria and/or organizational standards used by the operator of the media file storage and distribution platform in which the digital media files will be ingested. The digital media files may lack a minimum technical quality imposed by the media file storage and distribution platform. For example, data source 104b may provide an audio file that has a very low sample rate and/or audio bit depth—indicating that the audio quality is not good. In another example, data source 104b may provide an audio file in a specified file format that is incompatible for ingestion by the media file storage and distribution platform. In another example, the audio file may be corrupted or incomplete upon transfer from data source 104b. Other types of technical issues or deficiencies with media files can be contemplated within the scope of the technology described herein.

Media file validation module 110c can analyze each digital media file as captured from data source 104b and determine whether the digital media files are compliant with one or more technical ingestion criteria. Module 110c can identify one or more technical characteristics of the digital media file (e.g., bit/sample rate, file type, data integrity, etc.) and compare the identified technical characteristics against defined ingestion criteria to decide whether to continue with ingestion of the file. When module 110c determines that a digital media file falls below the defined criteria, module 110c can flag the corresponding file as non-compliant and issue a notification to client computing device 102 informing the user of the issue.

In some embodiments, the digital media files may contain unauthorized use of a third party's intellectual property. A common example is when a musician uses unlicensed samples of another artist's material in their songs. In these circumstances, the organization that operates the media file storage and distribution platform may wish to prevent these digital media files from being ingested until any licensing issues can be remedied. Media file validation module 110c can analyze each digital media file as captured from data source 104b and determine whether the digital media files are compliant with one or more organizational ingestion criteria. In the unlicensed sample use case described above, module 110c can generate a fingerprint of an audio waveform of the digital media file. Generally, an audio fingerprint comprises a representation of the audio that encapsulates information that is specific to the audio and which can be used to distinguish the audio from other audio files. A common way to generate an audio fingerprint that can be used by module 110c is spectrogram analysis, as described in P. Cano et al., “A Review of Algorithms for Audio Fingerprinting,” 2002 IEEE Workshop on Multimedia Signal Processing., St. Thomas, VI, USA, 2002, pp. 169-173, which is incorporated herein by reference.

Media file validation module 110c compares the fingerprint to a plurality of fingerprints generated from reference audio waveforms and flagging the digital media file as non-compliant upon determining that the fingerprint of the digital media file matches at least one of the fingerprints of the reference audio waveforms. For example, if a digital media file captured by system 100 includes a sample from another artist's music, module 110c can detect the existence of the sample and flag the file as non-compliant (or potentially non-compliant). In some embodiments, module 110c can identify the artist, album, song title, and other identifying information associated with the sampled music and store that information for review prior to ingestion.

Turning back to FIG. 2, once the digital media files have been validated for ingestion by module 110c, package generation module 110d compiles (step 210) metadata for the one or more digital media files into a second data structure. In some embodiments, package generation module 110d converts the CSV file generated by media file ingestion module 110b into another structured format (e.g., .xls or .xlsx format (Microsoft® Excel™)) by calling a create_excel_from_csv function. This function reads the CSV file and allocates the corresponding artists/album/track data into one or more columns in an .xls file. Exemplary pseudocode for the create_excel_from_csv function is provided below:

```
def create_excel_from_csv(csv_filename, artist_name):
  # turning csv into dataframe. trying to find bettere way still
  df = pd.read_csv(csv_filename)
  # current excel format, change by adding different headers
  excel_columns = [
    ‘UPC’, ‘ISRC/Selection #’, ‘Tracklisting’, ‘Configuration’, ‘Artist’,
‘Title’,
    ‘Feature Artist (if applicable)’, ‘Album Title (if applicable)’,
‘Presentation Label’,
    ‘WBS#’, ‘Genre’, ‘Security’, ‘Action’, ‘Preorder Date’, ‘Preorder
Timed Launch’,
    ‘Original Release Date’, ‘Explicit’, ‘Waterfall’, ‘Primary Artist’,
‘DSP Exclusivity’, ‘Territories’, ‘NOTES’
  ]
  excel_df = pd.DataFrame(columns=excel_columns)
  for index, row in df.iterrows( ):
    excel_df = pd.concat([excel_df, pd.DataFrame({
      ‘UPC’: [row[‘UPC’]],
      ‘ISRC/Selection #‘: [row[‘ISRC’]],
      ‘Tracklisting’: [row[‘Track Number’]],
      ‘Configuration’: [row[‘Configuration’]],
      ‘Artist’: [artist_name],
      ‘Title’: [row[‘Track Name’]],
      ‘Album Title (if applicable)’: [row[‘Release Name’] if
row[‘Configuration’] != ‘single’ else ‘’],
      ‘Genre’: [row[‘Genre’]],
      ‘Original Release Date’: [row[‘Original Release Date’]],
      ‘Explicit’: [‘Yes’ if ‘explicit’ in row[‘Track Name’].lower( )
else ‘No’],
      ‘Waterfall’: [‘Yes’ if row[‘Configuration’] in [‘album’, ‘ep’,
‘multitrack single’] else ‘No’],
      ‘Primary Artist’: [artist_name]
    })], ignore_index=True)
  date_str = datetime.now( ).strftime(‘% Y-%m-%d’)
  excel_filename = f“data/{artist_name}_releases_{date_str}.xlsx”
  excel_df.to_excel(excel_filename, index=False)
  print(f“Data saved to {excel_filename}”)
  return excel_filename
```

It should be appreciated that the above approach is merely exemplary and package generation module 110d can utilize other methodologies to generate a data structure compatible for ingestion by the digital media file storage and distribution platform.

Package generation module 110d then generates (step 212) a package file comprising the first data structure, the second data structure, and the one or more digital media files for ingestion by a digital media storage and distribution platform. In some embodiments, module 110d creates a .ZIP archive that contains the CSV file, the Excel file, and the digital media files downloaded from data source 104b as described above. Module 110d can store the .ZIP file in data store 112 for use by package ingestion module 110e in completing the ingestion of the digital media files and related data/metadata into the digital media storage and distribution platform. Exemplary pseudocode for creating the package file as a .ZIP file is provided below:

```
def create_zip_file(artist_name, release_name, date_str, excel_filename,
cover_art_url):
  zip_filename =
f“output/{artist_name}_Ingestion_{datetime.now( ).strftime(‘%Y-%m-%d’)}.zip”
  os.makedirs(os.path.dirname(zip_filename), exist_ok=True)
  with zipfile.ZipFile(zip_filename, ‘w’) as zipf:
    image = resize_image(cover_art_url)
    image_filename = f“{release_name}_cover.jpg”
    image_path = f“downloads/{image_filename}”
    image.save(image_path, “JPEG”)
    zipf.write(image_path, os.path.basename(image_path))
    zipf.write(excel_filename, os.path.basename(excel_filename))
    audio_folder = f“downloads/{release_name}”
    for root, _, files in os.walk(audio_folder):
      for file in files:
        zipf.write(os.path.join(root, file),
os.path.relpath(os.path.join(root, file), audio_folder))
  print(f“ZIP file created: {zip_filename}”)
```

As shown above, one component of the package file generation is the creation of an image file that contains cover art for the corresponding album. In some embodiments, a URL for the cover art image is provided as part of the data transfer from data source 104a (described above). Package generation module 110d can be configured to capture the cover art image from the designated URL and store an image file in data store 112 that will be included in the ingestion package, using the resize_image function. In some embodiments, module 110d can resize the original cover art image to be compatible with ingestion. Exemplary pseudocode for image resizing is provided below:

```
def resize_image(image_url, size=(1400, 1400)):
  response = requests.get(image_url)
  image = Image.open(BytesIO(response.content))
  image = image.resize(size, Image.Resampling.LANCZOS)
  return image
```

Once the package is created, package ingestion module 110e can be configured to connect to an external digital media file storage and distribution platform and provide the package file to the digital media file storage and distribution platform for ingestion. In some embodiments, module 110e transmits the package file to the external platform, which then extracts and processes the CSV file, Excel file, and digital media files.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application, and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for digital media file identification and ingestion, the system comprising a server computing device with a memory for storing computer-executable instructions and a processor that executes the computer-executable instructions to:
capture, from a first data source, media catalog information associated with an entity based upon first entity indicia provided by a client computing device;
compile the media catalog information into a first data structure;
capture, from a second data source, one or more digital media files associated with the entity based upon second entity indicia provided by the client computing device;
scan the one or more digital media files for compliance with one or more ingestion criteria;
compile metadata for the one or more digital media files into a second data structure; and
generate a package file comprising the first data structure, the second data structure, and the one or more digital media files for ingestion by a digital media storage and distribution platform.

2. The system of claim 1, wherein the server computing device interfaces with the first data source using a first application programming interface (API) and the server computing device interfaces with the second data source using a second API.

3. The system of claim 1, wherein scanning the one or more digital media files for compliance with one or more ingestion criteria comprises, for each digital media file:
generating a fingerprint of an audio waveform of the digital media file;
comparing the fingerprint to a plurality of fingerprints generated from reference audio waveforms; and
flagging the digital media file as non-compliant upon determining that the fingerprint of the digital media file matches at least one of the fingerprints of the reference audio waveforms.

4. The system of claim 1, wherein scanning the one or more digital media files for compliance with one or more ingestion criteria comprises, for each digital media file:
determining an audio resolution of an audio waveform of the digital media file; and
flagging the digital media file as non-compliant upon determining that the audio resolution of the digital media file is lower than a threshold audio resolution.

5. A computerized method of digital media file identification and ingestion, the method comprising:
capturing, by a server computing device from a first data source, media catalog information associated with an entity based upon first entity indicia provided by a client computing device;
compiling, by the server computing device, the media catalog information into a first data structure;
capturing, by the server computing device from a second data source, one or more digital media files associated with the entity based upon second entity indicia provided by the client computing device;
scanning, by the computing device, the one or more digital media files for compliance with one or more ingestion criteria;
compiling, by the computing device, metadata for the one or more digital media files into a second data structure; and
generating, by the computing device, a package file comprising the first data structure, the second data structure, and the one or more digital media files for ingestion by a digital media storage and distribution platform.

6. The method of claim 5, wherein the server computing device interfaces with the first data source using a first application programming interface (API) and the server computing device interfaces with the second data source using a second API.

7. The method of claim 5, wherein scanning the one or more digital media files for compliance with one or more ingestion criteria comprises, for each digital media file:
generating a fingerprint of an audio waveform of the digital media file;
comparing the fingerprint to a plurality of fingerprints generated from reference audio waveforms; and
flagging the digital media file as non-compliant upon determining that the fingerprint of the digital media file matches at least one of the fingerprints of the reference audio waveforms.

8. The method of claim 5, wherein scanning the one or more digital media files for compliance with one or more ingestion criteria comprises, for each digital media file:
determining an audio resolution of an audio waveform of the digital media file; and
flagging the digital media file as non-compliant upon determining that the audio resolution of the digital media file is lower than a threshold audio resolution.
